(19) United States
(12) Patent Application Publication
(10) Pub. No.: US 2008/0256199 A1
(43) Pub. Date: Oct. 16, 2008

(54) ATTACHING FILES FROM THE ATTACHMENTS AVAILABLE IN A USER'S MAIL BOX

(76) Inventor: Harikrishna Pesala, Andhra Pradesh (IN)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 11/758,127

(22) Filed: Jun. 5, 2007

(30) Foreign Application Priority Data
Apr. 13, 2007 (IN) 823/DEL/2007

(51) Int. Cl. G06F 15/16

(52) U.S. Cl. 709/206

(57) ABSTRACT

Techniques are provided to a user for attaching files that are available in the user's mail box. Previous email messages are saved, along with any file attachments, in the mail box. When composing a new message and the user intends to attach files to the new message, the files that are available for attachment are not limited to the files that are saved on the user's computer. Available files to attach include the file attachments that are saved in the user's mail box and other files that are stored in an online storage system, which service may be provided by the same entity that provides the email service to the user.

### CROSS-REFERENCE TO RELATED APPLICATION

This application is related to and claims the benefit of priority from Indian Patent Application No. 823/DEL/2007 filed in India on Apr. 13, 2007, entitled “ATTACHING FILES FROM THE ATTACHMENTS AVAILABLE IN A USER'S MAIL BOX”; the entire content of which is incorporated by this reference for all purposes as if fully disclosed herein.

### FIELD OF THE INVENTION

The present invention relates to attaching files to messages, and more particularly to providing online sources from which to attach files to messages.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Sending and receiving emails is a common practice with the advent of the Internet. Email service providers provide not only a designated mail box to a user, but also tools to send and receive email messages, manage such email messages, and maintain a list of contacts associated with the user.

Many emails contain attachments of files, such as word processing documents, executable files, images, audio, and video. Email service providers typically limit the size of file attachments because sending large files increases network traffic and may slow significantly the corresponding email service for other users of the service. The limit typically applies to the total size of all the file attachments (if there is more than one attachment) rather to an individual attachment.

However, even with a limit on the size of email attachments, downloading email attachments (i.e., from a user's mail box to the user's computer) and uploading files (i.e., from the user's computer to be attached to email messages) may require a significant amount of time, especially for users with a slow Internet connection and for mobile / PDA users that have a (slow) wireless connection. Furthermore, many mobile devices have relatively low storage capacities, resulting in a smaller number of files that such mobile devices are able to download and upload compared to desktop computers with larger storage capacities.

Based on the foregoing, there is a need to reduce the time required to attach files to all types of electronic messages.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow diagram that illustrates steps to attach files that are available from a user's mail box, according to an embodiment of the invention;

FIG. 2 is a block diagram that illustrates a view that is presented to the user when the user is attaching files to an email message, according to an embodiment of the invention; and

FIG. 3 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. For example, embodiments of the invention are described in the context of email. However, other messaging contexts that apply include instant messaging (IM), in which files that are already stored on online servers associated with the IM service may be attached to an instant message. In other instances, well-known structures and devices are shown in block diagram form in order to avoid unnecessarily obscuring the present invention.

### Attaching Files That are Available From the User's Mail Box

According to an embodiment of the invention, one or more files that are saved in a user's mail box are attached directly to an email message. As a result, if the user has not saved all file attachments to the user's computer, then the number of available attachments increases because current approaches limit the source of file attachments to the user's computer.

One significant benefit of this approach is that the user is not required to download or upload any files as long as the files are already saved “in” (i.e., in association with) the user's mail box. Another benefit is that network traffic is reduced considerably.

Furthermore, if a user has not yet downloaded a file attachment (from a previous email message in the user's mail box) to the user's computer and wishes to attach that file to a new email message, then the above approach removes multiple time-intensive steps that the user would have otherwise taken. For example, the user would have had to (1) scan through the user's mail box to identify the appropriate email message that included the file attachment, (2) download the file to the user's computer, and finally (3) upload the file to the new email message that has not yet been sent. Even scanning through the user's mail box may require several steps of opening and scanning multiple pages if the user has received many email messages since the appropriate email message was received.

Users of computers with slow Internet connections may experience a substantial decrease in the time required to attach files to an email message. Other users that may experience performance benefits include users that use mobile devices, such as Internet-enabled phones and/or PDAs.

As used hereinafter, a “file attachment” is a file that is sent with an email message. A typical email message comprises a subject, a body, and any file attachments. A file is said to be “attached” to an email message if the file is part of the email message that was sent to a user.

As used hereinafter, a “mail box” (or inbox) is a logical storage unit, provided by an email service provider, for a particular user. A mail box “stores” email messages that have been sent to the user and, optionally, that have not been deleted by the user. If a user “deletes” an email message, then the email service provider may still store the email message even though the mail box indicates that the email message is deleted.

### Attaching Files That are Available From an Online Storage System

According to an embodiment of the invention, one or more files that are stored in an online storage system are attached to an email message. Either the user, or a third party, may have saved the files to the online storage system. An email service provider may comprise an online storage system. In other words, a user's mail box may be part of the online storage system.

Alternatively, the online storage system may be separate from the email service. The entity that provides the service of the online storage system may be the same entity that provides the email service. For example, if the email service is Yahoo! Mail, then the online storage service may be Yahoo! Briefcase. Yahoo! Briefcase is an online storage service that allows users to store files on Yahoo! servers rather than, or in addition to, the user's computer. If the entity that provides the service of the online storage system is the same entity that provides the email service, then the time required to upload a file from the online storage system to the email service may be a fraction of the time required to upload the file if the file were uploaded from the user's computer.

The files that are stored in the online storage system may have been file attachments that a user transferred from the user's mail box to the online storage system. Additionally or alternatively, the files that are stored in the online storage system may have been uploaded from one or more computers of the user and/or one or more computers of one or more other users.

In a related embodiment, when a user wishes to attach one or more files to a message, the user is provided the option to select, for attachment, files that are stored through the email service and/or the online storage service. Additionally, the user may be provided the option to select files from the user's computer.

### Flow Diagram

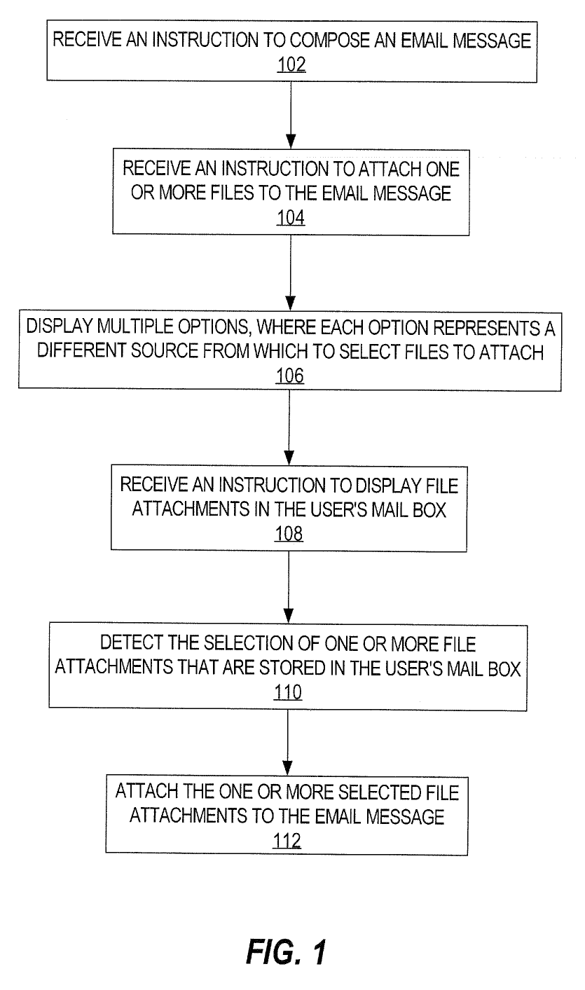

FIG. 1 is a flow diagram that illustrates steps to attach files that are available from a user's mail box, according to an embodiment of the invention. At step 102, an email service receives an instruction from the user to compose a new email message. At step 104, the email service receives an instruction from the user to attach one or more files to the new email message.

At step 106, the email service displays (or causes to be displayed via the user's browser executing on the user's computer) multiple options of sources from which to select files to attach. For example, one option may be “Mail Box”, another option may be “Briefcase” (e.g., as in Yahoo! Briefcase), and another option may be “My Computer.”

At step 108, the email service receives, from the user, an indication of the selection of the “Mail Box” option. As a result, the email service displays references to a subset of the files that are stored in association with previously-received email messages, to which the files are attached.

At step 110, the email service detects a selection, by the user, of one or more files that are attached to email messages in the user's mail box. At step 112, the email service attaches the one or more selected files to the new email message.

### Attachment View

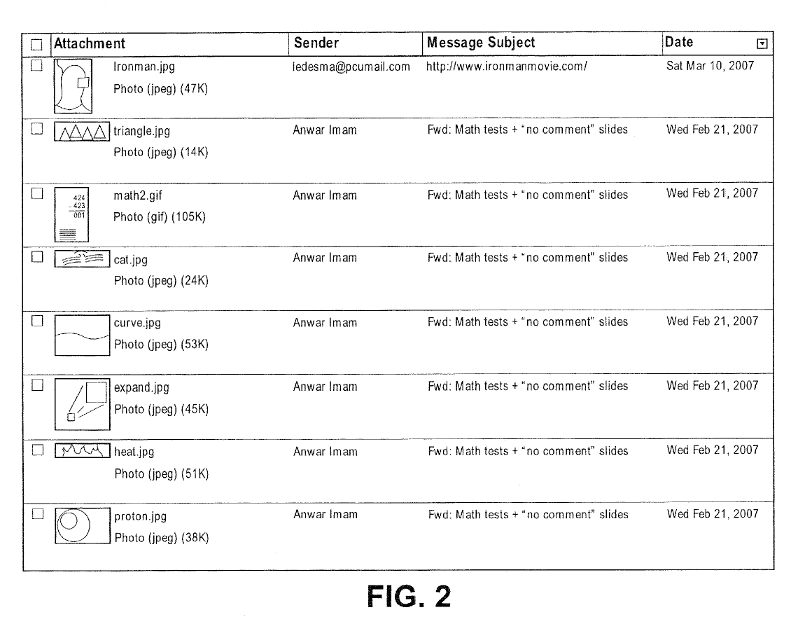

FIG. 2 is a block diagram that illustrates a view that is presented to a user when the user is attaching files to a message, according to an embodiment of the invention. Such a view is referred to as an “attachment view.” In this example, the attachment view displays references to file attachments that are stored in association with the user's mail box. The attachment view may alternatively or additionally display references to files that are stored in an online storage system.

In FIG. 2, each reference to a file attachment includes a thumbnail image of the corresponding file attachment. In some cases, a thumbnail image might not be displayed, such as when the corresponding file attachment is an executable file or a video. Also, in FIG. 2, each displayed file reference includes (a) the name of the file attachment, (b) the user that sent the corresponding email message, (c) the subject of the corresponding email message, (d) the date in which the corresponding email message was received, and (e) a selection box to select the file to attach to a message.

The file references that are displayed to the user may be ordered based on certain criteria. For example, the file references may be ordered based on the date in which the corresponding messages were received (as in FIG. 2), or the date in which the files were saved (in the context of a separate online storage system). Alternatively or additionally, the file references may be ordered based on who sent the corresponding messages, or who saved the files (in the context of a separate online storage system). Other criteria include, but are not limited to, the subject of the corresponding message and the size of the file.

In an embodiment, the file references that are displayed to a user may be stored in a hierarchical manner. A user of a mail box or an account with an online storage system may organize file attachments based on the content of the file. For example, a user may create one folder for family-related files, another folder for work-related files, another folder for hobby-related files, etc. Furthermore, each folder may contain subfolders that correspond to the sender of the file, date, and/or other criteria. This is similar to the attachment view of most applications when the user is presented a view of the user's computer desktop and an option to traverse the drives and/or folders of the user's computer. Therefore, the view of files to attach may provide the option to traverse the user-created folders. Alternatively, the view may “flatten” the folders by displaying only files and not folders. For example, if the files displayed in FIG. 2 were organized into folders or a hierarchy of folders, then the view would be a flattened view of the files.

### Hardware Overview

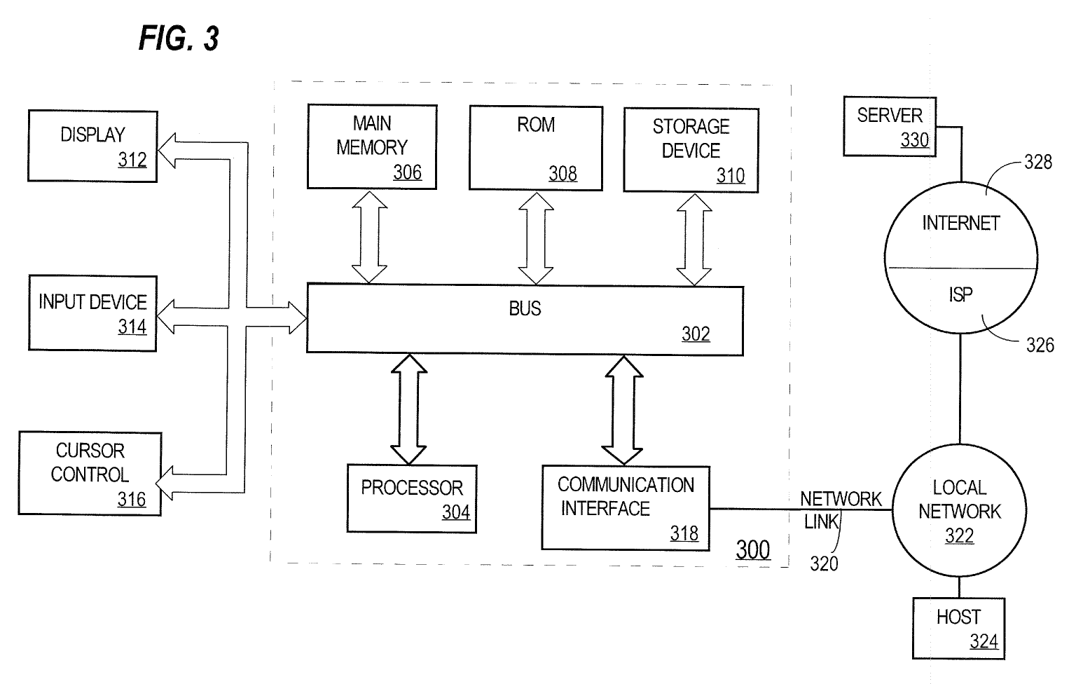

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 300, various machine-readable media are involved, for example, in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for attaching files to messages, the method comprising:
receiving a plurality of messages, wherein each message in a subset of the plurality of messages include one or more file attachments of a plurality of file attachments that are received with the subset;
based on first input from a user, displaying references to a subset of the plurality of file attachments;
receiving second input that indicates the user's intention to attach one or more file attachments, of the plurality of file attachments, to a particular message;
wherein the plurality of file attachments are stored on one or more storage devices that are separate from a computer from which the user issued the first input and the second input;
based on the second input, attaching the one or more file attachments to the particular message; and
sending the particular message to the intended recipient(s).

2. The method of claim 1, wherein each reference of the plurality of references include at least one of a thumbnail image of a file attachment, a name of the file attachment, a name of the user that sent the message with which the file attachment was sent, or the date in which the file attachment was received.

3. The method of claim 1, wherein at the time the one or more file attachments are attached to the particular message, the one or more file attachments are not stored on the computer.

4. The method of claim 1, wherein the message is an email message.

5. The method of claim 1, wherein the message is an instant message.

6. The method of claim 1, further comprising, in response to receiving the second input, sending a plurality of options to be displayed to the user, wherein:
a first option is to select one or more file attachments of the plurality of file attachments;
a second option is to select one or more files that are stored on the computer; and
a third option is to select one or more files that are stored in an online storage system that does not store the plurality of messages.

7. The method of claim 6, wherein the online storage system is associated with a message service that received the plurality of messages.

8. The method of claim 1, wherein:
the subset of the plurality of file attachments are stored in a hierarchy of folders;
two of the references are references to file attachments that are stored in different folders of the hierarchy of folders; and
the two references are displayed to the user at the same instant.

9. The method of claim 1, wherein the computer is a mobile device.

10. A method for attaching files to messages, the method comprising:
receiving first input that indicates a user's intention to compose a message;
receiving second input that indicates the user's intention to attach one or more files to the message;
based on the second input, displaying references to a plurality of files that are stored in an online storage system;
receiving third input that indicates the user's intention to attach one or more files, of the plurality of files, to the message;
based on the third input, attaching the one or more files to the message; and
sending the message to the intended recipient(s).

11. The method of claim 10, wherein the user uploaded a second subset of the plurality of files to the online storage system from one or more computers associated with the user.

12. The method of claim 10, wherein the online storage system stores provides a message service that provides the user the ability to compose the message.

13. The method of claim 10, wherein the online storage system provides one or more services that are each different than a message service that provides the user the ability to compose the message.

14. The method of claim 10, wherein:
the plurality of files are stored in a hierarchy of folders;
two of the references are references to files that are stored in different folders of the hierarchy of folders; and
the two references are displayed to the user at the same instant.

15. The method of claim 1, wherein the message is one or an email message or an instant message.

16. A machine-readable medium carrying one or more sequences of instructions which, when executed by one or more processors, causes the one or more processors to perform the method recited in claim 1.

17. A machine-readable medium carrying one or more sequences of instructions which, when executed by one or more processors, causes the one or more processors to perform the method recited in claim 2.

18. A machine-readable medium carrying one or more sequences of instructions which, when executed by one or more processors, causes the one or more processors to perform the method recited in claim 3.

19. A machine-readable medium carrying one or more sequences of instructions which, when executed by one or more processors, causes the one or more processors to perform the method recited in claim 4.

20. A machine-readable medium carrying one or more sequences of instructions which, when executed by one or more processors, causes the one or more processors to perform the method recited in claim 5.

21. A machine-readable medium carrying one or more sequences of instructions which, when executed by one or more processors, causes the one or more processors to perform the method recited in claim 6.

22. A machine-readable medium carrying one or more sequences of instructions which, when executed by one or more processors, causes the one or more processors to perform the method recited in claim 7.

23. A machine-readable medium carrying one or more sequences of instructions which, when executed by one or more processors, causes the one or more processors to perform the method recited in claim 8.

24. A machine-readable medium carrying one or more sequences of instructions which, when executed by one or more processors, causes the one or more processors to perform the method recited in claim 9.

25. A machine-readable medium carrying one or more sequences of instructions which, when executed by one or more processors, causes the one or more processors to perform the method recited in claim 10.

26. A machine-readable medium carrying one or more sequences of instructions which, when executed by one or more processors, causes the one or more processors to perform the method recited in claim 11.

27. A machine-readable medium carrying one or more sequences of instructions which, when executed by one or more processors, causes the one or more processors to perform the method recited in claim 12.

28. A machine-readable medium carrying one or more sequences of instructions which, when executed by one or more processors, causes the one or more processors to perform the method recited in claim 13.

29. A machine-readable medium carrying one or more sequences of instructions which, when executed by one or more processors, causes the one or more processors to perform the method recited in claim 14.

30. A machine-readable medium carrying one or more sequences of instructions which, when executed by one or more processors, causes the one or more processors to perform the method recited in claim 15.
